(19) United States
(12) Patent Application Publication
(10) Pub. No.: US 2004/0206123 A1
(43) Pub. Date: Oct. 21, 2004

(54) Method and device for the forming of glasses and/or glass ceramics

(76) Inventors: Ulrich Fotheringham, Wiesbaden (DE); Hauke Esemann, Worrstadt (DE); Bernd Hoppe, Ingelheim (DE); Andreas Hirach, Ingelheim (DE); Dirk Weidmann, Mainz (DE); Thoralf Johansson, Nieder-Olm (DE)

Correspondence Address: BAKER & DANIELS, 111 E. WAYNE STREET, SUITE 800, FORT WAYNE, IN, 46802

(21) Appl. No.: 10/474,625

(22) PCT Filed: Apr. 9, 2002
(86) PCT No.: PCT/EP02/03924

(30) Foreign Application Priority Data
Apr. 11, 2001 (DE) 101 18 260.0

(51) Int. Cl. C03B 23/025

(52) U.S. Cl. 65/103; 65/374.12; 65/374.13; 65/288; 65/107

(57) ABSTRACT

The invention relates to a method and device for the forming of bodies (2) made from glass or glass ceramic in order to produce a three-dimensional end product. A short-wave IR radiation (3) is thus used, furthermore a mould (1) for forming a three-dimensional body (2) made from glass or glass ceramic. According to the invention, the mould (1) is made from a material with a high reflectivity and a high degree of remission thus cooling the mould (1).

The invention relates to a method and a device for forming glasses and/or glass ceramics, in particular starting glasses for the manufacture of glass ceramics using short-wave infrared radiation. A heating and/or forming method of this type is described in detail in DE 199 38 808 A1, DE 199 38 807 A1, and DE 199 38 811 A1. The resulting end product is a three-dimensional formed body, e.g. a baking mold, a wash-basin or a fume hood for kitchens. In the process, three-dimensional formed bodies of the mentioned types, for example, made of flat glass, are created. Depending on the shape of the three-dimensional body, the degree of forming—as seen in a sectional view through the three-dimensional body—is variable in size. An example is a baking mold that has a baking cavity that has a contour with a floor area, a sloped circumferential wall and a flat rim area. The degree of forming between the floor and the circumferential wall and between the circumferential wall and the rim area is relatively high.

DE 199 38 811 A1 describes a device for manufacturing glass ceramic parts by a forming process from a glass ceramic molded blank. In this document, the walls of a hollow radiation cavity are designed so that they reflect IR-radiation. The same approach is applied in the devices according to the patents DE 199 38 808 A1, EP 0 133 847 B1, and U.S. Pat. No. 4,789,771 A1.

Furthermore, it is known to use steel molds in order to form glass, for example, from RGM-17. Such a material is suitable as long as the heating of the glass is done either on the outside of the mold or using conventional radiation heating (e.g. Kanthal elements) or glass flame heating. However, if in order to heat the glass lying on the mold, short-wave IR radiation is used, to which the glass is for the most part transparent, then a large portion of the impinging radiation penetrates through the glass and gets to the steel mold, which because of its low reflectivity, absorbs a considerable portion of the impinging radiation energy and heats up as a result. This leads very quickly to the adhering of the glass to the mold and upon subsequent heating to the oxidation (scaling) of the mold. Thus, a mold made of steel is not readily suitable for molding by heating using short-wave infrared radiation.

The purpose of the invention is to design a method and a device of the type named at the beginning so that with it, bodies made of glass or glass ceramic can be heated and formed in a mold using short-wave IR-radiation, without causing an adhering of the body to the mold and/or scaling of the mold.

This purpose is achieved by the characteristics of the independent claims.

As a material for the mold, a suitable metal of high reflectivity comes into consideration, for example, polished aluminum. However, a different metal can also be used, e.g. copper, which is coated with a suitable highly reflective material, so that the coating constitutes the forming surface. The coating should have a reflectivity of greater than 80%, 90% is better, and in particular 95%. In this way, the aforementioned disadvantages of the adherence of the body made of glass or glass ceramic and the scaling of the mold as a result of too much heating are prevented.

According to the invention, the material of the mold for forming the end product is thus correspondingly designed so that it has a high luminosity coefficient and/or a high reflectivity. The aforementioned state-of-the-art, especially the patent DE 199 38 811 A1, involves a different approach. In this patent, it is not the walls of the forming mold that are reflective, but instead the walls of a hollow radiation cavity.

For many application purposes, molds made of aluminum or copper come into consideration. As the coating material, gold can be used, which can be applied onto the substrate by galvanization or by vapor-depositing. The forming surface can be polished.

Molds also fundamentally considered are ones made of fused silica having a high luminosity coefficient of preferably greater than 90%, but greater than 95% is even better. A ceramic mold of this type has the disadvantage that the manufacture of very smooth three-dimensional shaped surfaces is associated with a very high expense and in no case does it achieve a quality as is state-of-the-art in metal processing.

It is favorable to select a material for the mold that has a high thermal conductivity (>50 W/mK, especially preferred: >100 W/mK), since the mold then has a very homogenous temperature distribution and the formation of spots that are too hot or too cold, due to the variably intense radiation of the different surfaces, can not occur. Suitable materials in this regard are, for example, copper or aluminum.

In particular in the case of a coated mold, it is mostly necessary to cool it since otherwise the mold temperature will reach a value at which the coating is destroyed (though not immediately due to the high reflectivity, but instead slowly as a result of longer and/or frequent heating cycles). Also, the material properties of the basic material limit the permissible mold temperature so that even for uncoated molds, cooling might be necessary. Cooling of the mold is preferably done with water. In the process, the adjusted mold temperature may not fall below a material-dependent value, however, since otherwise the temperature of the glass lying on the mold required for forming will no longer be reached. In order to reach this temperature, it is provided according to the invention to construct the cooling device and the mold as two separate structural components between which an additional structural component can be applied as a defined heating resistor so that in this way the desired mold temperature can be established, while the cooling device has a temperature near room temperature.

While the mold is cooling, the following problem can occur: the relatively cold mold draws heat away from the body to be formed. This can lead to the glass temperature remaining below the value required for forming. This is very disadvantageous, for example, in the forming of a flat glass plate into a baking shell. The flat plate is placed on the mold so that the plate stays in contact with the mold at a circumferential region, while the glass plate has no contact with the mold in the inner area. As a result, a temperature gradient becomes established between the glass in the contact area and the glass within this inner area. The necessary forming temperature is thus also not present in the transition zone of the glass plate. Thus, it is not possible to accurately form the plate to the mold that is used.

This problem is solved according to an additional concept of the invention in that measures are taken in order to minimize the local heat extraction that the mold exerts on the body in the areas where there are high degrees of forming of the body.

It also be advantageous to take the aforementioned measures when the mold is not cooled separately. A local heat extraction by the material to be formed could otherwise occur at certain points on the mold.

The measures can be performed in different ways. The simplest measure consists in providing the mold with a recess in the area of the high degree of forming so that in this area there is no contact between the forming surface and the surface of the body that is to be formed which faces this surface. Accordingly no heat extraction occurs there as a result. The temperature of the body to be formed reaches the value necessary for forming.

Other measures are also possible, for example, the cooling of the mold can be designed such that the directly affected areas where there are high degrees of forming are cooled less or not at all, and that accordingly less or no heat is extracted from the body to be formed in these areas.

The invention is explained in greater detail using the drawing. In it, the following are shown in detail:

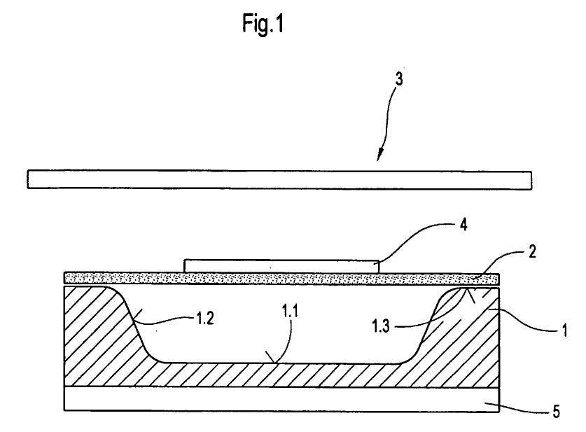

FIG. 1 shows a vertical section of a device according to the invention in a schematic diagram.

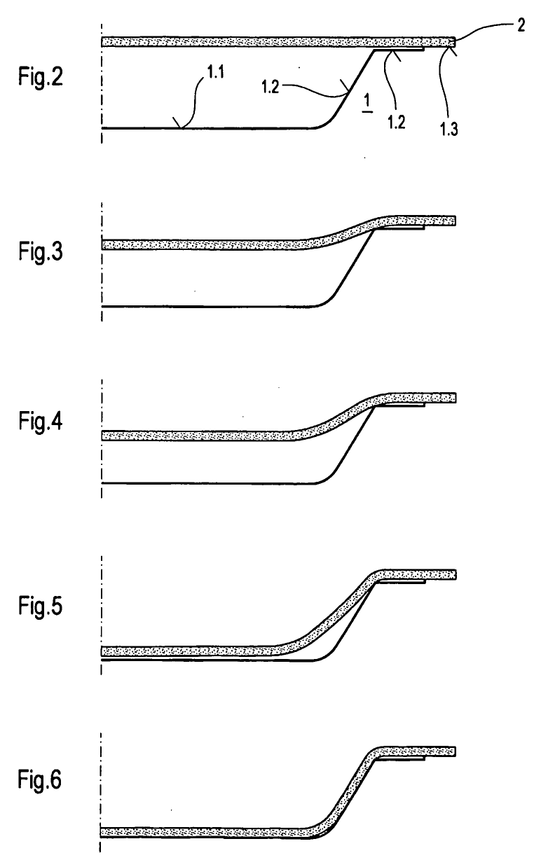

FIGS. 2-6 show the workflow of the forming method during the manufacture of a baking shell.

In FIG. 1, a mold 1 for manufacturing a baking shell is shown in detail. The mold 1 has a forming surface comprising a floor surface 1.1, which runs horizontally in the case presented here, a side surface 1.2 and a seat surface 1.3. The mold 1 consists in the case presented of a metal that has a reflectivity of 90%. Moreover, the thermal conductivity is very high. This has the advantage that it a homogenous temperature distribution occurs in the mold which acts favorably on the quality of the product to be manufactured.

A glass disk 2 is placed on the mold 1. The glass disk 2 has a rectangular shape exactly like the mold 1 in the overhead view. The glass disk 2 thus rests with its circumferential areas on the seat surface 1.3 of the mold 1.

An important element is a heating device 3. This involves a short-wave infrared radiation device with a temperature-color of 2500 K. The glass disk 2 has a thickness of 3.7 mm and a width of 250 mm. It is located at a distance of 55 mm from the radiation emitters of the heating device 3. The distance to the floor surface 1.1 of the mold 1 is 25 mm. The region of the center of the disk is shielded by a quartz plate 4 against radiation. This prevents the glass from becoming too soft there, which can lead to a so-called pit formation.

The mold 1 is cooled. For this purpose, it rests on a cooling device 5. This involves a case that has water flowing through it. The mold 1 rests unconnected on the cooling device 5. In this way, the heat transfer is relatively low.

The mold has, in addition, suction holes (not shown), which open on the forming surface 1.1, 1.2, 1.3. On the suction holes, a vacuum can rest so that the glass plate softened by the heating device 3 can be pulled onto the forming surface.

The glass plate 2 is heated at the beginning of the process at an initial temperature of 600 degrees Celsius. The mold 1 is heated to 250 degrees Celsius. The cooling water flowing in the cooling device 5 is at room temperature. The power of the radiation emitter is 50 kW. The vacuum is then applied to the aforementioned suction holes, when the temperature of the glass plate 2 in the area of the bending edge between the side surface 1.2 and the seat surface 1.3 has reached a value of greater than 800 degrees Celsius.

FIGS. 2 to 6 show individual phases of the forming method of the glass plate 2 shown in FIG. 1.

An important detail can be seen especially well in FIG. 2. There, the floor surface 1.1, the side surface 1.2, and the seat surface 1.3 are shown. However, the seat surface 1.3 is processed and specifically, it is provided with a recess, resulting in a lowered surface 1.4 which of course also goes around the mold 1. After the glass plate 2 is placed onto the mold 1 and/or onto the seat surface 1.3, there is an open intermediate space between the lowered surface 1.4 and the lower surface of the glass plate 2. This means that no contact occurs between the glass plate 2 and the mold 1 in this region. Accordingly, no heat is extracted from the glass plate 2 there. The glass plate 2 retains the necessary temperature which it obtains from the heating device 3. This temperature reaches the necessary value for forming.

FIG. 3 shows the condition in which the glass plate softens and is somewhat sunken in its center region because of its own weight.

FIG. 4 shows a condition in which in addition to the effect of the own weight, a suction force is applied by the aforementioned suction holes.

FIG. 5 shows a subsequent stage.

In FIG. 6 the end condition is almost achieved. The glass plate 2 then lies almost completely on the forming surface of the mold 1.

In a practical embodiment example, the perpendicular distance between the seat surface 1.3 and the lowered surface 1.4 is 1 mm. Smaller or larger values are conceivable, for example 0.5 to 7 mm.

The lowered surface 1.4 has a length of several millimeters, here measured in the horizontal direction. Optimal lengths of this lowered surface are 5 to 20 mm, preferably 10 to 15 mm.

1. Method for forming bodies made of glass or glass ceramic for the purpose of manufacturing a three-dimensional end product, having the following process steps:
1.1 the body is placed on a forming mold (4 and heated using short-wave IR-radiation;
1.2 as a material of the mold, a material having a high luminosity coefficient or high reflectivity is selected;
1.3 measures are taken in order to minimize the local heat extraction that the mold exerts on the body in the areas of high degrees of forming of the body.

2. Device for forming a body made of glass or glass ceramic for the purpose of manufacturing a three-dimensional end product, having the following characteristics:
2.1 a form-producing mold;
2.2 a short-wave IR-heating device for heating the body;
2.3 the material of the mold has a high luminosity coefficient or a high reflectivity at least in the area of the forming surface;
2.4 measures are taken in order to minimize the local heat extraction that the mold exerts on the body in the areas of high degrees of forming of the body.

3. Device according to claim 2, characterized in that the mold is insulated from heat extraction in the areas of high degrees of forming of the body.

4. Device according to claim 3, characterized in that the mold rests on a separate cooling device that is flowed through by a cooling medium, preferably water.

5. Device according to claim 2, characterized in that the forming surface of the mold is made of a metallic coating.

6. Device according to claim 5, characterized in that the mold is made of metal.

7. Device according to claim 2, characterized in that the reflectivity of the forming surface is 80, preferably at least 90%.

8. Device according to claim 7, characterized in that at least the forming surface of the mold is made out of a fused silica.

9. Device according to claim 8, characterized in that the fused silica has a luminosity coefficient of at least 90%, and preferably 95%.

10. Device according to claim 2, characterized in that the mold has a recess, between a seat surface carrying the body and a side surface arranged inside the seat surface and sloped towards it, whereby the bottom of the recess is formed from a lowered surface.

11. Device according to claim 3, characterized in that the forming surface of the mold is made of a metallic coating.

12. Device according to claim 4, characterized in that the forming surface of the mold is made of a metallic coating.

13. Device according to claim 3, characterized in that the reflectivity of the forming surface is 80, preferably at least 90%.

14. Device according to claim 4, characterized in that the reflectivity of the forming surface is 80, preferably at least 90%.

15. Device according to claim 5, characterized in that the reflectivity of the forming surface is 80, preferably at least 90%.

16. Device according to claim 6, characterized in that the reflectivity of the forming surface is 80, preferably at least 90%.

17. Device according to claim 3, characterized in that the mold has a recess, between a seat surface carrying the body and a side surface arranged inside the seat surface and sloped towards it, whereby the bottom of the recess is formed from a lowered surface.

18. Device according to claim 4, characterized in that the mold has a recess, between a seat surface carrying the body and a side surface arranged inside the seat surface and sloped towards it, whereby the bottom of the recess is formed from a lowered surface.

19. Device according to claim 5, characterized in that the mold has a recess, between a seat surface carrying the body and a side surface arranged inside the seat surface and sloped towards it, whereby the bottom of the recess is formed from a lowered surface.

20. Device according to claim 6, characterized in that the mold has a recess, between a seat surface carrying the body and a side surface arranged inside the seat surface and sloped towards it, whereby the bottom of the recess is formed from a lowered surface.
